(19) United States
(12) Patent Application Publication
(10) Pub. No.: US 2015/0305087 A1
(43) Pub. Date: Oct. 22, 2015

(54) Automatically Adjustable Projector with Wireless Data Stream

(71) Applicant: de Blake, Pacific Palisades, CA (US)

(72) Inventor: Gillian Leigh Blakeney, Pacific Palisades, CA (US)

(73) Assignee: de Blake, Pacific Palisades, CA (US)

(21) Appl. No.: 14/256,128

(22) Filed: Apr. 18, 2014

(51) Int. Cl. H04W 84/10; H04W 88/02; H04W 84/20

(52) U.S. Cl. CPC H04W 84/10; H04W 84/20; H04W 88/02; G02B 13/16

(57) ABSTRACT

The invention is directed toward a system and method for transferring and projecting audiovisual files from a wireless device to a projector. The system and method is further directed toward a unique method of manipulating images on a wireless device and projecting the manipulated images from the projector. The system comprises a wireless device and projector with a movable projector head. The wireless device transmits an audiovisual file to the projector. As the wireless device is repositioned, the movable projector head on the projector moves in response. A user can control the angle of projection by changing the angle of the wireless device. A user can also manipulate the image of the audiovisual file on the touch screen display of the wireless device. The changes in the image are transmitted to the projector and the projector projects the changed image.

### TECHNICAL FIELD

The invention relates generally to projectors and more particularly to a system and method for projecting a signal received from a wireless device and controlling the projection angle in reference to the position of the wireless device.

### BACKGROUND OF THE INVENTION

Personal projectors are known in the art. Historically, users of personal projectors have utilized projectors which utilize film to present home movies. With the advent of the VHS tape and the camcorder, personal home projectors were disregarded in favor of VHS tape players which could play home movies directly on a user's home television. Since then projectors have been primarily used in educational and business settings. Overhead projectors take images of items placed within a presentation frame and project those images to a viewing screen. Digital projectors have been utilized which project images and movies from computers or compact disc players to a viewing screen.

With the advent and mass utilization of the smart phone, more and more personal content is being created and consumed through these smart phones. Users can download and store digital files on their own smartphone. Additionally, users can record movies or take pictures with the camera on their smartphone. Those files are stored on the memory card within the smartphone until a user connects the smartphone to a personal computer. Then the user may sync the smartphone with the personal computer and save the digital files on the personal computer. Only then can the user utilize a standard digital projector by connecting the personal computer with the projector. This type of system is cumbersome and time intensive. What is needed is a personal projector that allows a user to project and display content directly from a personal smartphone through a personal projector.

Additionally, projectors have historically been static units that do not move in any direction. A user places the projector in the location that is desired before use. Most times this means that a user projects images directly at a wall. However, if a user desires to adjust the image up or down the process can become cumbersome if the user desires to have the projected image located outside of the normal placement by the projector. Users solve this problem normally by placing books or other items underneath the front of the projector to increase the angle of the projection. What is needed is a projector that a user can easily and automatically rotate as desired without the use of other items.

Lastly, standard projectors have limited use of user controls through a remote device. The remote control may allow a user to play a video with standard controls such as pause, rewind, and fast forward. A remote control for a projector may have a zoom function. However, these controls are not easily used as a user must zoom in with a button and then pan around with a series of arrow buttons. What is needed is a graphical user interface which permits a user to manipulate images being projected by simple and intuitive tactile manipulation.

### SUMMARY OF THE INVENTION

The invention is directed toward a system and method for transferring and projecting audiovisual files from a wireless device to a projector. The system and method is further directed toward a unique method of manipulating images on a wireless device and projecting the manipulated images from the projector.

The system comprises a wireless device and a projector. The wireless device has a graphical user interface and transmits audiovisual information wirelessly to the projector. The projector comprises a processor, a transceiver, a memory unit, a control panel, a speaker, an electromotor, a light source, a lens, and a movable projector head. The movable projector head automatically moves in response to movement by the wireless device.

The invention may be practiced in many various embodiments. The lens may be a wide angle lens. The wireless device may have an accelerometer integral to the wireless device. The wireless device may be a wireless cellular phone. Furthermore, the control panel may permit a user to control the parameters of use of the projector. The parameters may include a sleep function, brightness, and volume. Additionally a user may control the projection image through the graphical user interface on the wireless device. The projector may further comprise a power source. In one embodiment the wireless device has a camera integral to the wireless device and the movable projector head projects a projection image to the location viewed through the camera.

In another embodiment of the invention, the system comprises a wireless device and a projector. The wireless device has a graphical user interface and transmits audiovisual information wirelessly to the projector. The projector further comprises a projector body and a base. The projector body comprises a processor, a transceiver, a memory unit, a control panel, a speaker, a light source, and a lens. The base comprises an electromotor. The projector body sits in the base. The projector body automatically moves in response to movement by the wireless device.

This embodiment of the invention may be practiced in many various embodiments as well. The lens may be a wide angle lens. The wireless device may have an accelerometer integral to the wireless device. The wireless device may be a wireless cellular phone. Furthermore, the control panel may permit a user to control the parameters of use of the projector. The parameters may include a sleep function, brightness, and volume. Additionally a user may control the projection image through the graphical user interface on the wireless device. The projector may further comprise a power source. In one embodiment the wireless device has a camera integral to the wireless device and the movable projector head projects a projection image to the location viewed through the camera.

The invention is also directed toward a method of projecting an image from a wireless device. The method comprises accessing an audiovisual file from nonvolatile memory unit integral to the wireless device where the audiovisual file comprises an audio component and a visual component, transmitting the audiovisual file to a projector, receiving the audiovisual file in the projector with a transceiver, amplifying the audio component of the audiovisual file through a speaker integral to the projector, projecting the visual component of the audiovisual file through a lens, generating position information of the wireless device through an accelerometer integral to the wireless device, transmitting the position information to the projector, and moving the movable projection head in response to the position information received from the wireless device. The projector in the method comprises a processor, a transceiver, a memory unit, a control panel, a speaker, an electromotor, a light source, a lens, and a movable projector head.

In one embodiment of this method the lens is a wide angle lens, the wireless device has an accelerometer, the wireless device is a cellular mobile phone, the control panel permits a user to control the parameters of use of the projector, the parameters include a sleep function, brightness, and volume, and the projector further comprises a power source.

Furthermore, in another embodiment of the invention, the wireless device further comprises a visual touch screen display and the method further comprises manipulating the visual component of the audiovisual file on the visual touch screen display, generating a manipulation file comprising executable instructions for recreating the manipulations of the visual component, transmitting the manipulation file from the wireless device to the projector, receiving the manipulation file in the projector with the transceiver, executing the manipulation file with the processor in the projector, and changing the visual component in the projector in accordance with the instructions contained in the manipulation file.

In another embodiment of this method the lens is a wide angle lens, the wireless device has an accelerometer, the wireless device is a cellular mobile phone, the control panel permits a user to control the parameters of use of the projector, the parameters include a sleep function, brightness, and volume, the projector further comprises a power source, and the wireless device has a camera. In this embodiment the method further comprises generating specific position information in the wireless device from information received from the camera, transmitting the specific position information to the projector, and moving the movable projector head in response to specific position information.

### BRIEF DESCRIPTION OF THE DRAWINGS

FIG. 1 is a view of the system.

FIG. 2 is a view of the system.

FIG. 3 is a view of the system.

FIG. 4 is a view of the components of the projector.

FIG. 5 is a view of another embodiment of the projector.

FIG. 6 is a schematic showing the use of the system.

FIG. 7 is a schematic showing use of the system's graphical user interface.

FIG. 8 is a schematic showing use of the system's graphical user interface.

FIG. 9 is a view of the process utilized by the system.

FIG. 10 is a view of the file manipulation process.

### DETAILED DESCRIPTION OF THE DRAWINGS

Although the present invention will be described with reference to the exemplary embodiments shown in the drawings, it should be understood that the present invention can be embodied in many alternate forms or embodiments. In addition, any suitable size, shape or type of elements or materials could be used for the components found in the system. Various modifications to these embodiments will be readily apparent to those skilled in the art, and the generic principles defined herein may be applied to other embodiments without departing from the scope of the invention. Thus, the present invention is not intended to be limited to the embodiments shown, but is to be accorded the widest scope consistent with the system disclosed.

The various illustrative logical blocks, modules, circuits, and steps described in connection with the embodiments disclosed herein may be implemented as electronic hardware, computer software, or combinations of both. In one or more embodiments of the invention, the functions described herein may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. The operations of a method or algorithm may reside as one or any combination or set of codes and/or instructions on a tangible, non-transitory machine readable medium and/or computer-readable medium, which may be incorporated into a computer program product.

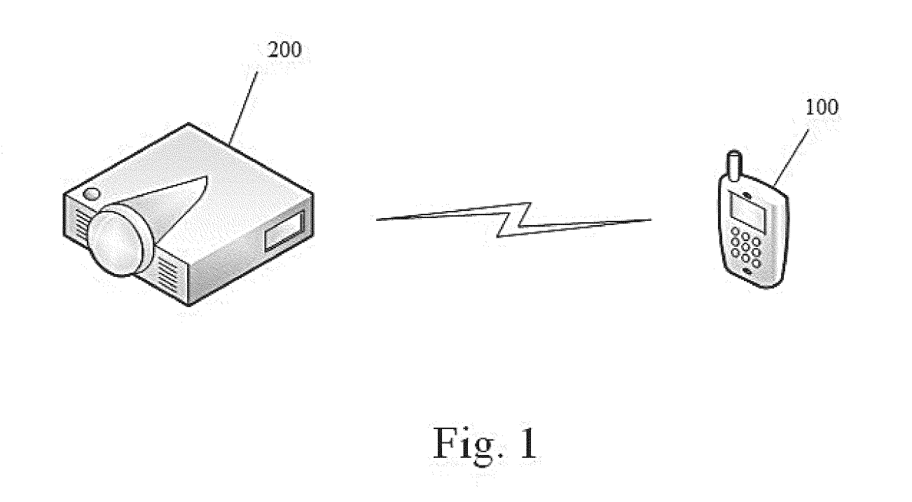

The invention is directed toward a system for projecting images and sound from a wireless device through a projector which may be controlled by the wireless device. As shown in FIG. 1, the system comprises a wireless device 100 in wireless communication with a projector 200. The wireless device 100 may be any type of wireless, web-enabled, personal computing device. The wireless device 100 may be a personal PDA, tablet computer, or wireless cellular phone. In the preferred embodiment the wireless device 100 is a wireless cellular phone.

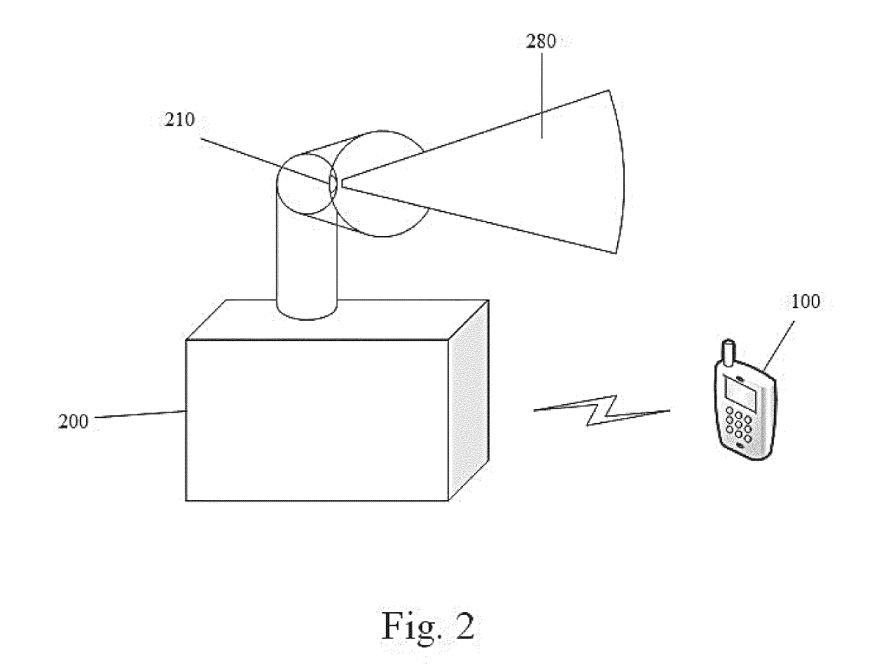

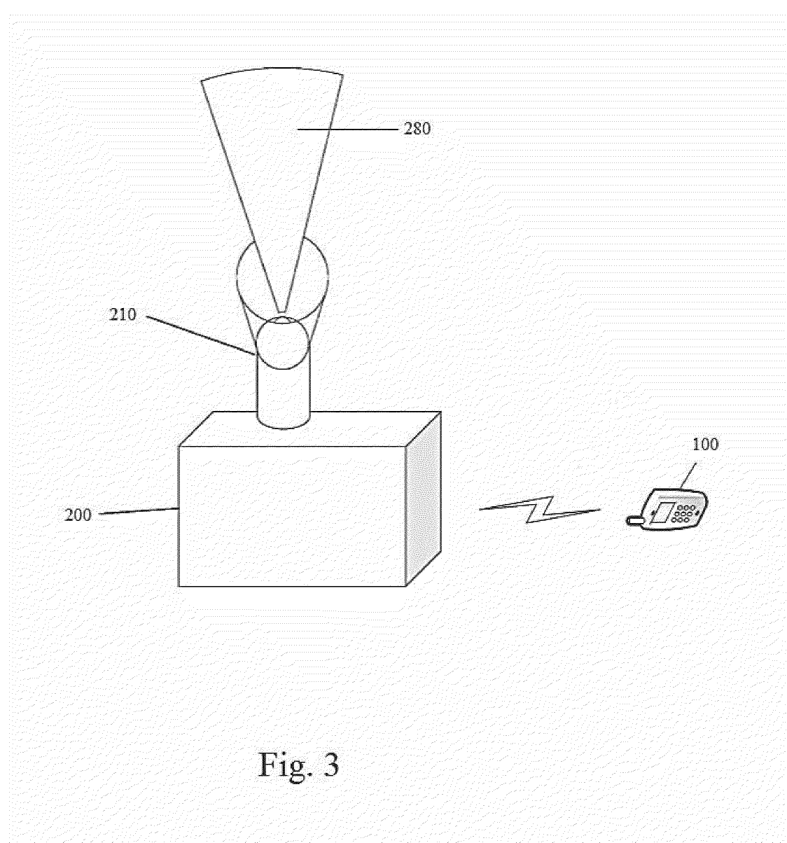

Referring to FIG. 2 and FIG. 3, the system is utilized to project the images and data received from the wireless device 100. The projector 200 has a movable projector head 210. The movable projector head 210 moves in response to the positioning of the wireless device 100. The movable projector head 210 directs the projection beam 280 in any direction. When in use, a user may direct the projector beam 280 towards a screen or a wall. When the wireless device 100 is held in a vertical position, the movable projector head 210 directs the projection beam 280 horizontally, as shown in FIG. 2. As shown in FIG. 3, when the wireless device 100 is put in a horizontal position, the movable projector head 210 directs the projection beam 280 upward. When in use in this manner, a user may direct the projection beam 280 at the ceiling. A user may then lay in bed or lay on the floor to watch the video being projected. In the preferred embodiment, the movable projector head 210 moves automatically in response to the direction that the wireless device 100 is pointed. For instance, the movable projector head 210 may direct the projection beam 280 to the location where the camera of the wireless device 100 is capturing. As the camera of the wireless device 100 is turned to the left, the movable projector head 210 directs the projector beam 280 to the left. As the camera of the wireless device 100 is turned to the right, the movable projector head 210 directs the projector beam 280 to the right. In one embodiment of the invention, the positioning and direction of the wireless device 100 is recorded by an accelerometer integral to the wireless device 100. As the accelerometer records the movements of the wireless device 100, those movements are transmitted to the projector 200, which moves the movable projector head 210 in the proper direction and distance in response to the movement of the wireless device 100.

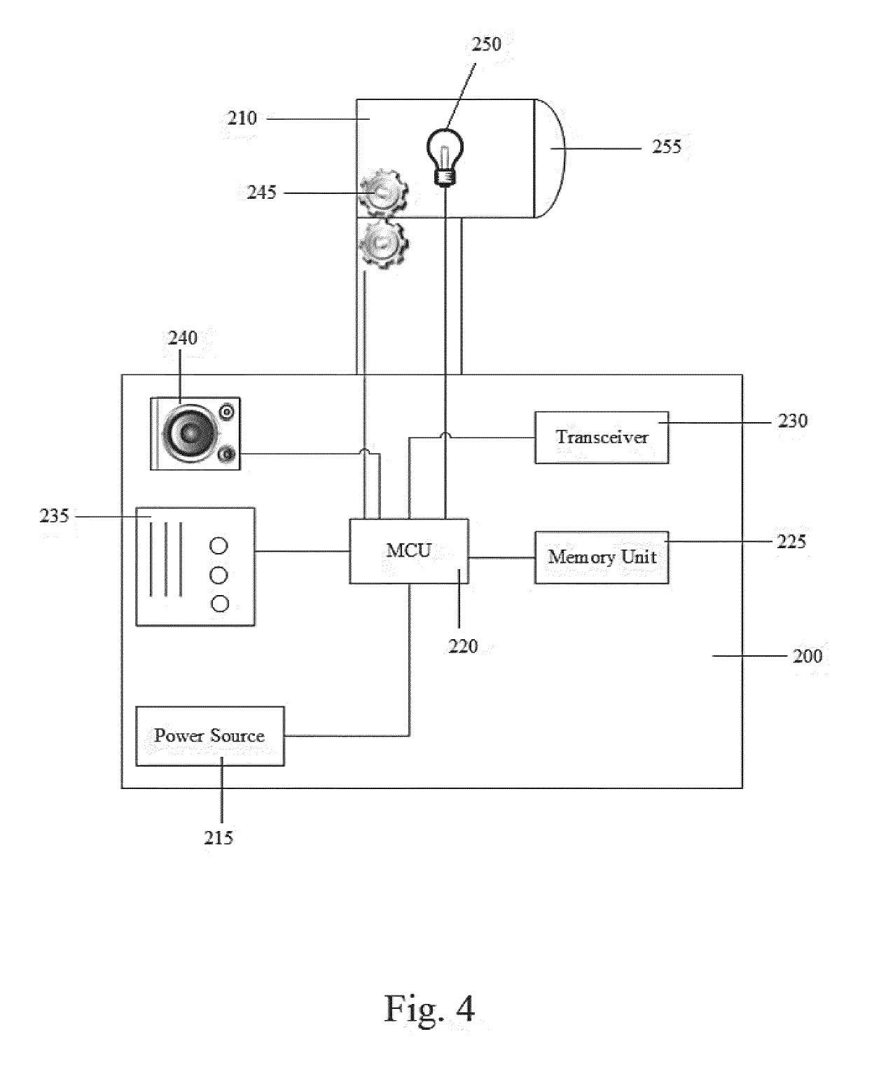

Referring to FIG. 4, the internal components of the projector 200 is displayed. In the embodiment shown, the projector has a power source 215. The power source 215 may be a battery pack or series of batteries. The power source 215 may be an external power source such as power from an outlet. The projector 200 is controlled by a central processing unit 220. The central processing unit 220 may have an additional memory unit 225. The memory unit 225 may be used to store audiovisual files which may be retrieved by a user and projected for users to watch. Additionally, the memory unit 225 may provide additional RAM for use in buffering the data stream received from the wireless device 100. The projector 200 has a transceiver 230 for sending and receiving data to and from the wireless device 100. The projector 200 contains a speaker 240 which amplifies and plays the audio stream data received from the wireless device 100. The projector 200 has a control panel 235 which allows a user to control the operation of the projector. The control panel 235 allows the user to control the projector in any way that the user may desire. The control panel 235 may have controls such as on/off, volume up/volume down, brightness adjustment, or setting the direction of the movable projector head 210. The projector 200 has a light source 250. The image is projected by a lens 255. In the preferred embodiment the lens 255 is a wide angle lens. The projector 200 has an electromotor 245 which operates to move the movable projector head 210. There may be one or more electromotors 245 operating in concert to ensure that the movable projector head 210 has a full range of motion.

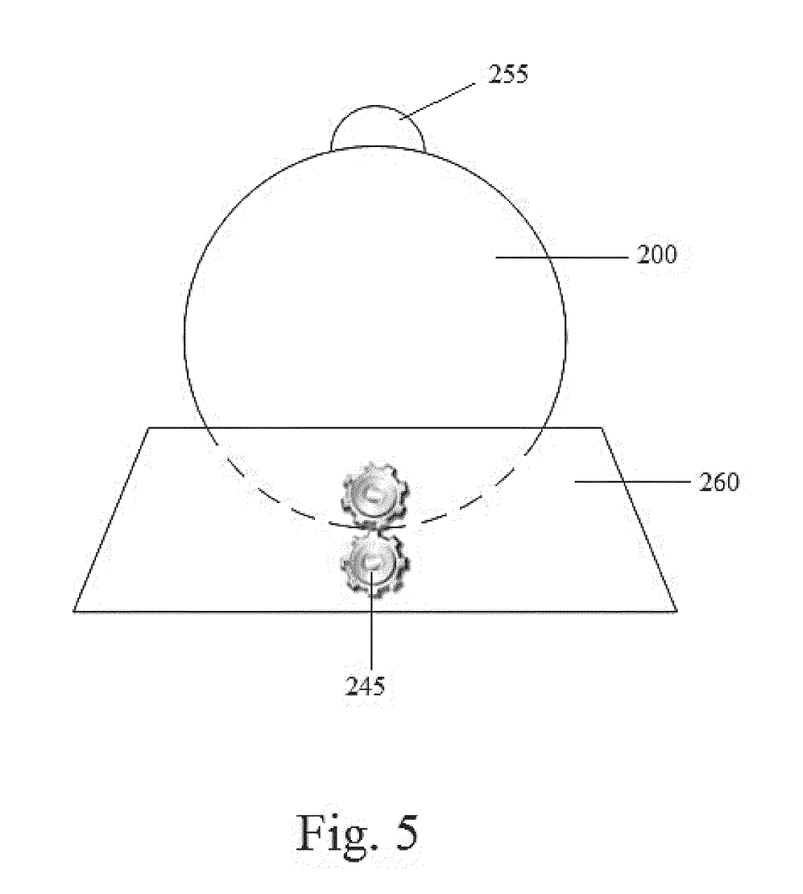

Referring to FIG. 5, an alternative embodiment of the invention is displayed. In this alternative embodiment of the invention the projector 200 has a spherical shape which sits in a base 260. The projector 200 may have one or more electromotors 245 which may be within the base 260 or the projector 200. In this embodiment the projector 200 has a fixed lens 255. In the preferred embodiment the fixed lens 255 is a wide angle lens. In this alternative embodiment of the invention the electromotors 245 rotate the entire body of the projector 200 within the base 260. As the wireless device 100 is held in a vertical position, the electromotors 245 rotate the body of the projector 200 so that the fixed lens 255 projects horizontally toward a wall or projection screen. As the wireless device 100 is held in a horizontal position, the electromotors 245 rotate the body of the projector 200 so that the fixed lens projects vertically toward the ceiling. Additionally, as the wireless device 100 is rotated to the left or to the right, the electromotors 245 rotate the body of the projector 200 within the base 260 so that the fixed lens projects respectively toward the left or to the right.

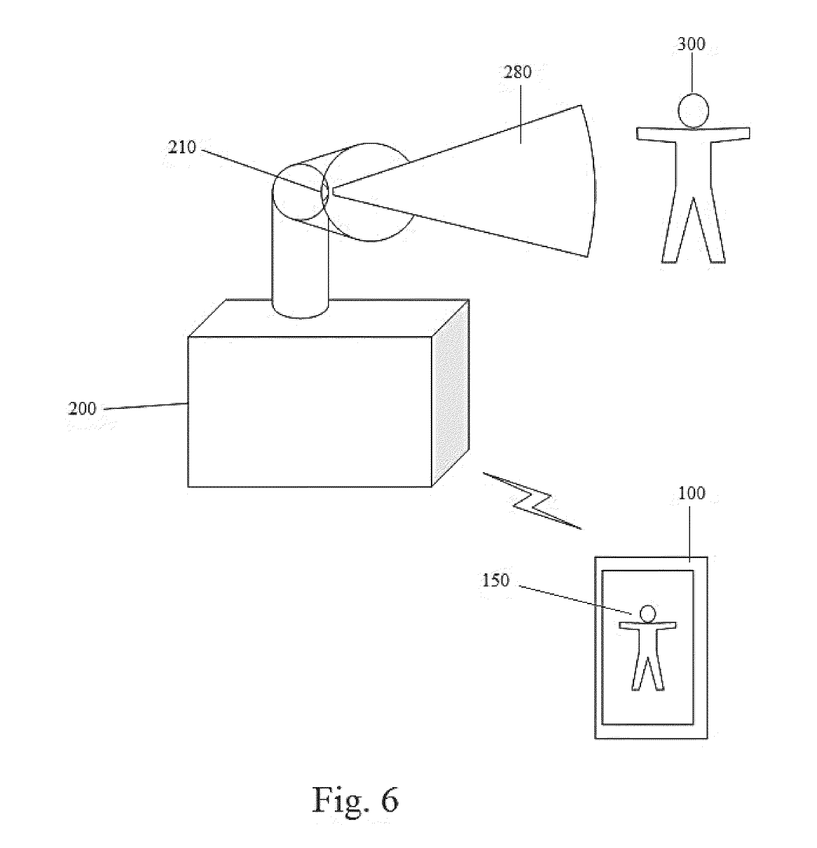

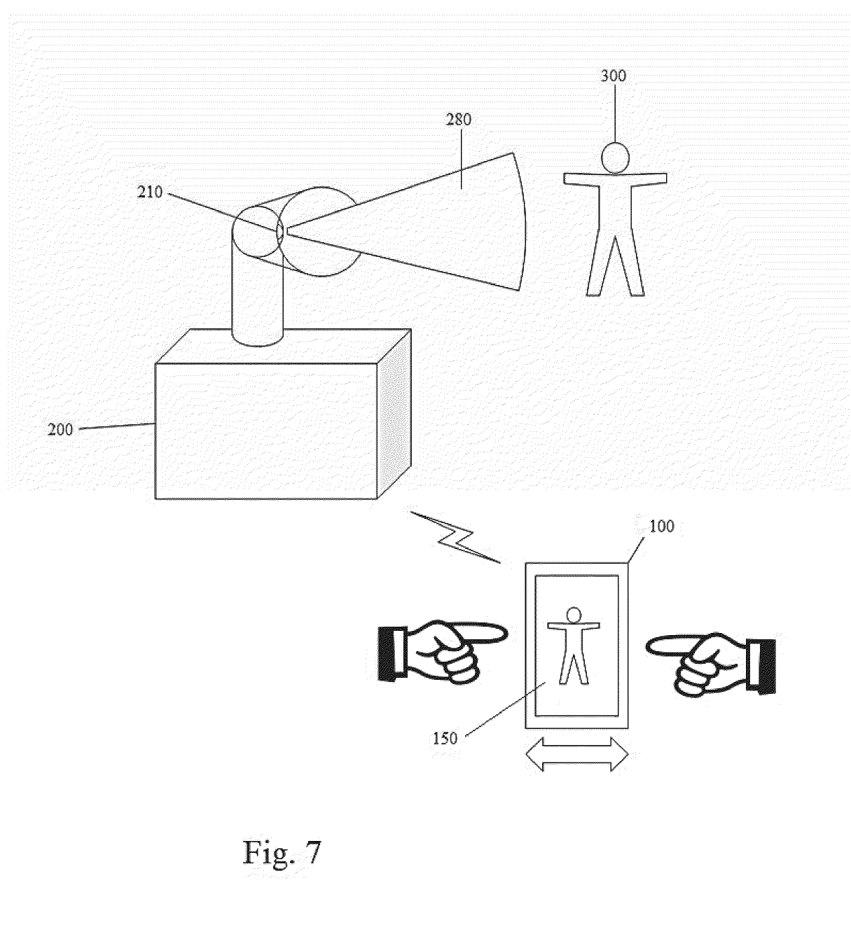

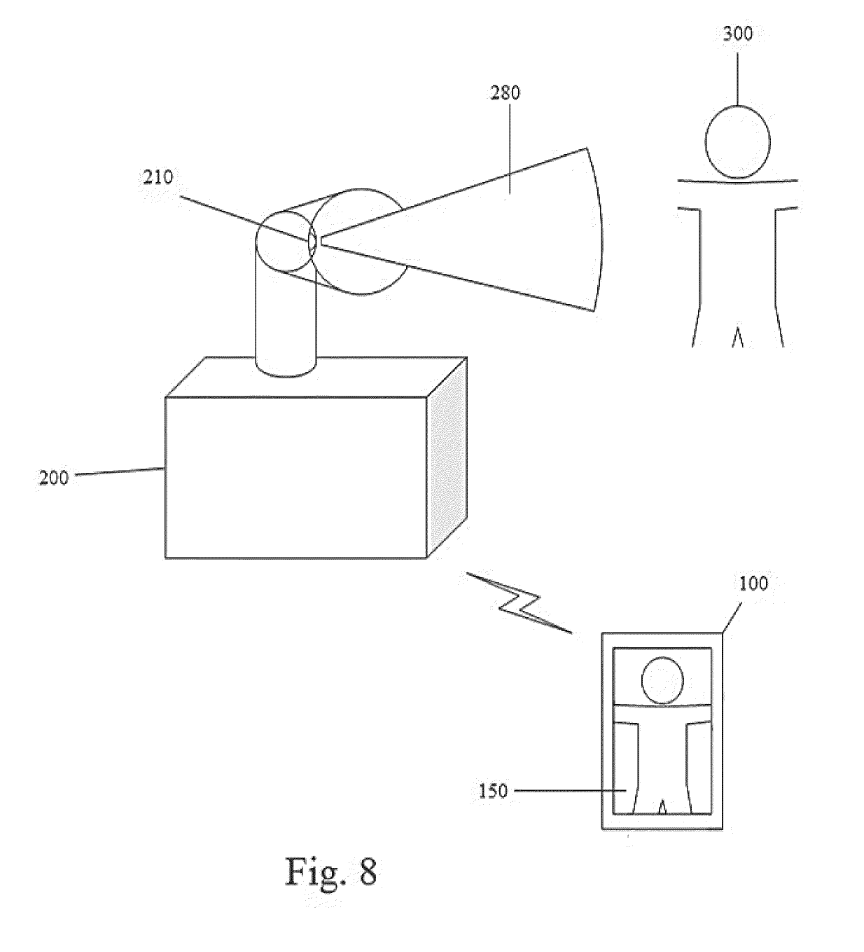

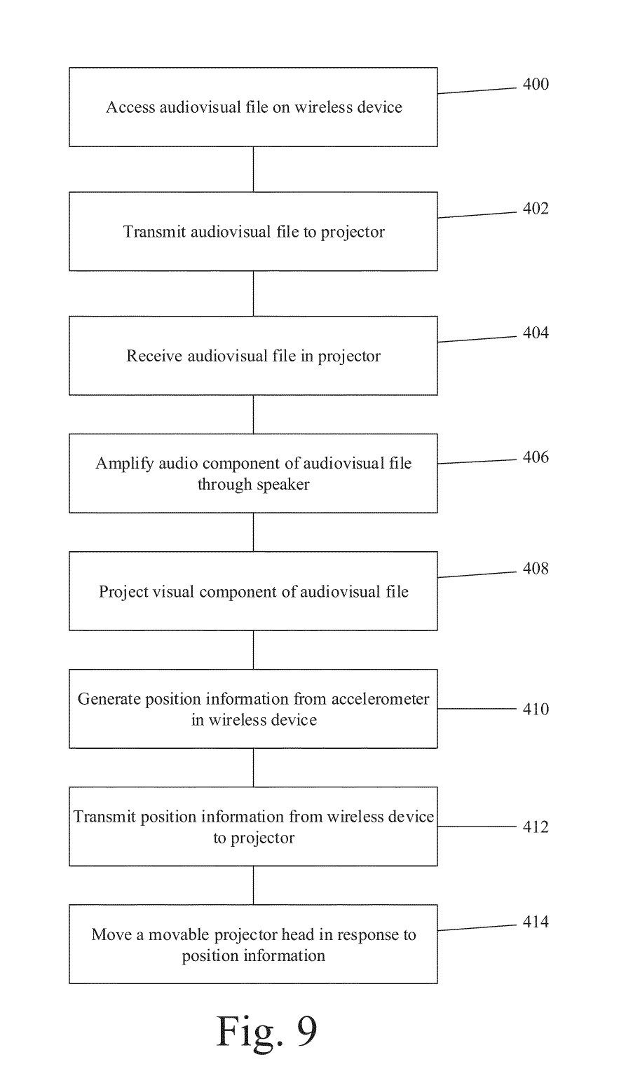

Referring to FIG. 6, FIG. 7, and FIG. 9, the system also includes a specialized graphical user interface operating on the wireless device 100. The specialized graphical user interface permits a user to manipulate the wireless device image 150 displayed on the wireless device 100 and have those manipulations projected through the projection beam 280 and render on the projection image 300. As shown in FIG. 6, the projection image 300 is identical to the wireless device image 150 that is displayed on the touch display screen of the wireless device 100. Referring to FIG. 7, a user can manipulate the wireless device image 150 by tactile interaction. Such tactile interaction may include dragging an image around through the display screen. As a user drags the wireless device image 150 around on the display screen of the wireless device, the projection image 300 moves around within the frame created by the projection beam 280. As shown by FIG. 7, a user may use two fingers to zoom the wireless device image 150 on the wireless device 100. As shown in FIG. 8, after the user zooms the wireless device image 150, the projector 200 also causes the projection image 300 to zoom.

A user uses the system in any manner desired by the user. In the preferred embodiment, the user plays audiovisual data stored on the wireless device 100. The audiovisual data is transmitted through a bluetooth signal to the projector 200. The projector 200 beams the video data through the projector beam 280 to create the projection image 300. The projector plays the audio data through the speaker 240. The wireless device 100 may still play the audio data from the audiovisual file at the same time that the speaker 240 plays the audio data. The audiovisual data may be any type of audiovisual file. The audiovisual data may include photos, videos, music, movies, and games. Additionally, the wireless device 100 may utilize standard audiovisual data that is incorporated with control software downloaded onto the wireless device 100.

In the preferred embodiment of the invention, a user uses the projector 200 for relaxation purposes when going to bed. The user lays in bed, sets position of the wireless device 100 such that the projection beam 280 projects the projection image 300 onto the ceiling. The audiovisual data on the wireless device 100 that is transmitted to the projector 200 is intended to be calming and soothing. For instance, the user can lay in bed while the projector 200 projects a looping video of fish in an aquarium tank and the speaker 240 plays soft and soothing music. The user can set a sleep function through the control panel 235 on the projector 200. The user can watch the video that is projected onto the ceiling of the bedroom until the user falls asleep. Then the sleep function will automatically turn off the projector 200 after a predetermined amount of time.

FIG. 9 displays a view of the process utilized by the system. First, an audiovisual file stored on a wireless device is accessed 400. The audiovisual file is then transmitted to the projector 402. The projector receives the audiovisual file 404. The projector amplifies the audio component of the audiovisual file through a speaker 406. The projector projects the visual component of the audiovisual file 408. The wireless device generates position information from information from an accelerometer integral to the wireless device 410. The wireless device transmits the position information from the wireless device to the projector 412. The movable projector head on the projector moves in response to the position information received from the wireless device 414.

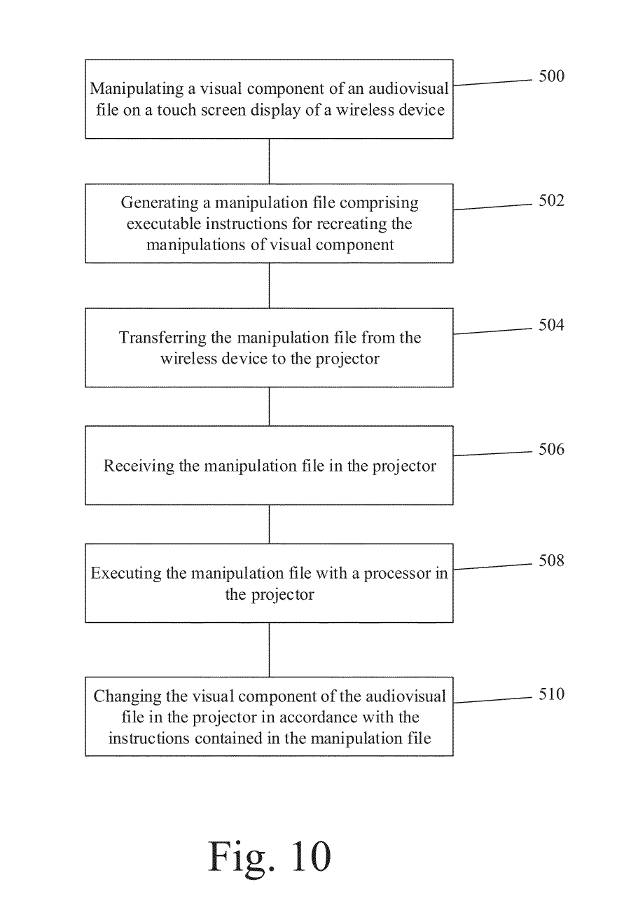

FIG. 10 displays the process of manually manipulating the image projected by the projector. First, a user manipulates the visual component of the audiovisual file on the touch screen display of the wireless device 500. The wireless device generates a manipulation file comprising executable instructions for recreating the manipulations of the visual component 502. The wireless device transfers the manipulation file to the projector 504. The projector receives the manipulation file 506. The process in the projector executes the manipulation file 508. The projector then changes the visual component of the audiovisual file in accordance with the instructions contained in the manipulation file 510.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A projection system comprising
a wireless device
said wireless device transmitting audiovisual information wirelessly to
said projector
said wireless device having a graphical user interface
a projector
said projector comprising
a processor
a transceiver
a memory unit
a control panel
a speaker
an electromotor
a light source
a lens
a movable projector head
wherein said movable projector head automatically moves in response to movement by said wireless device.

2. The system as in claim 1 wherein said lens is a wide angle lens.

3. The system as in claim 2 wherein said wireless device has an accelerometer.

4. The system as in claim 3 wherein said wireless device is a cellular mobile phone.

5. The system as in claim 4
wherein said control panel permits a user to control the parameters of use of the projector
wherein said parameters include a sleep function, brightness, and volume.

6. The system as in claim 5 wherein a user may control said projection image through said graphical user interface on said wireless device.

7. The system as in claim 6 wherein said projector further comprises a power source.

8. The system as in claim 7
wherein said wireless device has a camera
wherein said movable projector head projects a projection image to the location
viewed through said camera.

9. A projection system comprising
a wireless device
said wireless device transmitting audiovisual information wirelessly to
said projector
said wireless device having a graphical user interface
a projector
said projector comprising
a projector body, said projector body comprising
a processor
a transceiver
a memory unit
a control panel
a speaker
a light source
a lens
a base
said base comprising an electromotor
wherein said projector body sits in said base
wherein said projector body automatically moves in response to movement by said wireless device.

10. The system as in claim 9 wherein said lens is a wide angle lens.

11. The system as in claim 10 wherein said wireless device has an accelerometer.

12. The system as in claim 11 wherein said wireless device is a cellular mobile phone.

13. The system as in claim 12
wherein said control panel permits a user to control the parameters of use of the projector
wherein said parameters include a sleep function, brightness, and volume.

14. The system as in claim 13 wherein a user may control said projection image through said graphical user interface on said wireless device.

15. The system as in claim 14 wherein said projector further comprises a power source.

16. The system as in claim 15
wherein said wireless device has a camera
wherein said movable projector head projects a projection image to the location
viewed through said camera.

17. A method of projecting an image from a wireless device comprising
accessing an audiovisual file from nonvolatile memory unit integral to said wireless device
said audiovisual file comprising an audio component and a visual component
transmitting said audiovisual file to a projector
said projector comprising
a processor
a transceiver
a memory unit
a control panel
a speaker
an electromotor
a light source
a lens
a movable projector head
receiving said audiovisual file in said projector with said transceiver
amplifying said audio component of said audiovisual file through said speaker integral to said projector
projecting said visual component of said audiovisual file through said lens
generating position information of said wireless device through an accelerometer integral to said wireless device
transmitting said position information to said projector
moving said movable projection head in response to said position information received from said wireless device.

18. The method as in claim 17 wherein said wireless device further comprises a visual touch screen display, the method further comprising
manipulating said visual component of said audiovisual file on said visual touch screen display
generating a manipulation file comprising executable instructions for recreating the manipulations of said visual component
transmitting said manipulation file from said wireless device to said projector
receiving said manipulation file in said projector with said transceiver
executing said manipulation file with said processor in said projector
changing said visual component in said projector in accordance with the instructions contained in said manipulation file.

19. The method as in claim 18
wherein said lens is a wide angle lens
wherein said wireless device has an accelerometer
wherein said wireless device is a cellular mobile phone
wherein said control panel permits a user to control the parameters of use of the projector
wherein said parameters include a sleep function, brightness, and volume
wherein said projector further comprises a power source
wherein said wireless device has a camera
the method further comprising
generating specific position information in said wireless device from information received from said camera
transmitting said specific position information to said projector
moving said movable projector head in response to specific position information.

20. The method as in claim 17
wherein said lens is a wide angle lens
wherein said wireless device has an accelerometer
wherein said wireless device is a cellular mobile phone
wherein said control panel permits a user to control the parameters of use of the projector
wherein said parameters include a sleep function, brightness, and volume
wherein said projector further comprises a power source.
